(19) United States
(12) Patent Application Publication
(10) Pub. No.: US 2005/0111950 A1
(43) Pub. Date: May 26, 2005

(54) Attachable high lift implement for tractors and the like

(76) Inventors: Michael Edward Shepperd, Lebanon, IN (US); Brian Scott Shepperd, Lebanon, IN (US)

Correspondence Address: Michael Edward Shepperd, 915 West 500 North, Lebanon, IN, 46052, US

(21) Appl. No.: 10/967,526

(22) Filed: Oct. 18, 2004

Related U.S. Application Data
(60) Provisional application No. 60/512,128, filed on Oct. 17, 2003.

(51) Int. Cl. B66F 1/00

(52) U.S. Cl. 414/592

(57) ABSTRACT

A high lift material handling attachment for vehicles such as tractors, riding mowers, garden tractors, golf carts all terrain vehicles etc. wherein the material handling attachment may be front or rear mounted and vertical lifting power provided by a self contained power source or powered from the tractor etcs. own power source. A frame supports the vertical lift post and drive assembly that powers a movable trolley, which maybe fitted with a pitchfork assembly, flat platform, bucket, or other implement. The trolley attachment points allows variations such as rotating the forks 180 degrees, and lock their positions to about vertical. The fork can now be raised or lowered, by the operating persons control, and then used as a “rake” to move materials such as hay and straw away from walls etc., raked into a pile and ready to lift and transport. A flat platform may also be easily attached to transport and lower loads—such as sliding a bag of animal feed from a truck bed onto the platform and then transported where the load can be raised or lowered to a storage area.

Referring now to drawings in greater detail,

FIG. 1, part 62 is the main mounting support angle for eye bolts 42,44,46,48,50,52. The bottom round pipe of 22 passes thru these eyebolts before forks 26,28,30 are slipped thru the holes in 22 and locked in place by 32,34,36. Parts 38 and 40 are protective end caps. Pin 24 is a thru rod that holds the forks in a position, paralleled to the ground, by latch lever 118 which is released with solenoid 120 (when the operator pushes the release button, 12 volts is supplied to this push type solenoid) to release 24 and allows 22 to pivot within eyebolts 42,44,46,48,50,52. The weight of the load along with the weight of the forks and assembly causes the forks to drop to a vertical position and dropping the loaded material. Eyebolt 42 is shown with hardware 51, 53 on one side of 62 and 54, 56 on the backside. 51 and 56 are adjusted along with respective nuts on the other five eyebolts, to align with the bottom round pipe of 22 and permit easy rotation of shaft 22.

FIG. 2 is a view with forks 26,28,30 having been rotated 180 degrees, pins 32,34,36 reinserted and 22 allowed to drop to a vertical position and locked there with bar latch 118 mounted to the trolley assembly. In this mode the forks can be raised and lowered by the person operating the lifter and used as a rake to pull material away from walls etc, piled and ready to move. Parts 22 and 62 are fabricated from steel pipe and angle iron and “u” channel stock. Forks 26,28 and 30 are off the shelf pitch fork tines. Note these can be removed by first removing 32,34,36, and a flat load platform, bucket or other load carriers can be mounted in these fork holes and retained with the pins shown. FIG. 3A Is a perspective exploded view of the trolley assembly. 70,72 are the main side supports and are fabricated of steel angle and flat plate. Bolts 92,98,117A pass thru 70, on thru “V” groove rollers 78,82,80 on thru 72 and are retained by 94,96,100,102,117C,117D. These “V” groove rollers are made of cast iron and are off the shelf parts. They are equipped with roller bearings and zerk grease fitting.

FIG. 3B Shows a head-on view of these rollers. Bolt 86 along with its nut and washers hold the lift assembly in place on the trolley (FIG. 1) by passing thru holes 75 and 77 in 62 (with 62 located between 70 and 72 of FIG. 3A). Nut 90 is self-locking and is tightened to take out endplay but loose enough to allow the lift assembly to pivot within the trolley supports. Plate 76 first has bolts 74 and 110 pushed thru it and on thru holes 118 and 120. Springs 106 and 112 are slipped over these bolts and are held in place by washers 106 and 114 with locking nuts 108 and 116. Plate 76 along with springs 104 and 112 act as a shock absorber if the forks hit something solid while the person operating the tractor is moving forward. Nuts 108 and 106 are adjusted to “load” springs 104 and 112 to allow the shock absorber action but still hold the forks up under load.

FIG. 4 Shows latch lever 118 and its release solenoid 122. 122 is a 12-volt push type solenoid with a spring return. Applying 12 volt (from the tractor battery) to 122 causes it to lift pushing 118 up and unlatching from 24 in FIG. 1 causing the load to drop. Pin 124 is mounted on the outside of 72. Clip pin 126 is inserted in hole 140 then washer 128, cable pulley 130, washer 132 is pushed onto 124 and all retained by inserting 134 thru hole 138. Cable 132 is anchored at one end by securing to one end of 24 (hole 25 of FIG. 1). Cable 132 then routes under pulley 130 up and over pulley 134 down to and anchored to spring 136, a long expansion spring. Spring 136 is the attached to the bottom end of one of the rear upright supports. Cable length is adjusted to start stretching the 136 spring as the load platform travels down. This action re-latches the load platform (forks) as it is lowered.

FIG. 5 This is an exploded perspective view of the axle assembly. 154 Is the axle itself and is fitted with brass bushings 148,160,156,158. Caster wheels allow the wheels to automatically track the direction the tractor is driven without special “backing” skills by the operator. Washers 150 and 162 and nylon insert locknuts 152 and 164 are adjusted to take up and down play out of the wheel assemblies while allowing them to swivel. Cotter keys 153 and 165 lock the caster nuts. Bushings 156 and 158 are used to control wear and allow the axle 154 to rock on bolt 224. Bolt 224, FIG. 7, is attached to the bottom of the upright trolley support tube 222. This anchors the bottom of 222 bypassing thru hole 172 of FIG. 6, thru 156 and 158 (thus thru axle 154), and on thru hole 174 of FIG. 10A. In this way the axle 154 is anchored while fully able to rock and follow ground contours. Bolt 222 is held in place by washer 225A and locking nut 225B (FIG. 7).

FIG. 6 This is a perspective view of the lifters main frame. It shows the axle 154 setting in its normal position. The frame 170 is made of square steel tubing and has 3/16″ thick, 4″ wide steel plates 206, 208 and 210 welded to it. Worm gear drive case 196 is bolted to and supported by 208 and 210. 208 also extends down the inside of the square frame 170 and ends at the same level as 206. Upright 224-support bolt 172 passes thru 206 and 210 with the axle between. 198 and 200 are rubber faced friction drive wheels that couple energy from drive plate 258 FIGS. 9A,B and C. Bottom notches 212 and 214 allow the end of the frame to fit over bar 216 of FIG. 10B. Bar 216 is attached at each end to plates 185B and 185C, which are universal mounting plates that attach to the tractors (or other vehicles) frame to control and steer the lifter. Plates 176 and 178 are pivoted at the front end of bolts 180 and 186. These bolts are secured by nylon locknuts 184 and 190 with washers 182 and 188 between nuts and frame 170. 184 and 190 are tightened but loose enough for 176 and 178 to swing under bar 216. Clips 192 and 194 then secure these plates to frame 170 capturing bar 185A. This provides a rigid mount to the tractor while still allowing the lifter to pivot up and down keeping its wheels on the ground.

FIG. 7 This is a perspective view of the upright square steel tube trolley support 222 with its lower thru bolt 224, its upper mounting plate 250, rear supports 226 and 228. The length of 222 is set to give a high lift while still fitting thru a garage door. Its overall height can be manufactured to a length shorter or longer if desired. Hardware 227 and 229 are the bolts etc. that mount the rear supports to the main frame 170.

FIG. 8 is a straight on view of the backside of upright trolley support 222. Lower lift cable pulley 240 is attached by passing a pin thru bracket 230, thru 240, then thru bracket 232 and all held in place by clip pin 246. The top lift cable pulley is attached in the same method with pin 244 thru bracket 234, thru pulley 238, thru bracket 236 and retained with pin 248.

FIG. 9A Shows a “very flexible” 3/16 stainless steel cable 264 that is routed from winch drum 216, then under pulley 240, up thru the center of the upright support tube 222, over the top of pulley 238 and then down and attaches to trolley anchor 84 (also shown on FIG. 3A) There is a side view of the engine 252, a 12 volt electric clutch/brake 254, a drive belt 256 and an off the shelf, worm gear drive assembly “Module U” from Joyce Steel Belts, Dayton Ohio. It has a double-ended input shaft and a gear ratio of 40:1. This, or a greater ratio, creates a “self locking” feature that holds the load height at any distance. Both ends of its inputs shafts is fitted with a 6 inch rubber rimmed, replaceable friction drive wheels 198 and 200. These are also “off the shelf” parts. This 196 worm drives gear case is held rigid to the main lifter frame by brackets 208 and 210 as shown in FIG. 6. The gear drive 196-output shaft is fitted with a winch hub attached to lift cable 264. Lifting and lowering of the load platform is accomplished by following action. First, the power applied to friction drive plate 258 is controlled by a 12-volt electric clutch/brake assembly 254. This is the same clutch/brake system as used on many modern lawn and garden tractors. With engine 252 running and clutch/brake 254 engaged, belt 256 couples rotating power to friction drive plate 258. Note again the worm gear 196 is mounted solid to the frame and has 6-inch friction drive wheels on each end of its input shaft. Now look at

FIG. 9b. This is a rear view of drive 196 with drive plate 258 below it. Also note that drive plate 258 has a bearing below it with a shouldered mounting stud 262 thru its center. This stud 262 is mounted in a rotating bar 300, which will be explained shortly. Drive plate 258 rotates clockwise as viewed from the top but as friction wheels 198 and 200 are mounted to contact 258 on different sides of its center, having plate 258 contact drive wheel 198 will in turn cause worm gear 196 output winch hub to turn in one direction but rotating shaft 300 so drive plate 258 breaks contact with friction wheel 198 and then contacts wheel 200 will cause the winch hub of 196 to change its direction of rotation. This action causes lift cable 264 to either raise or lower the trolley 70 (FIG. 4C) and its attached load platform.

FIG. 9C Is a top view of the Drive system.

FIG. 10A an B Are perspective views of the main frame 170 and its attaching hardware to a vehicle.

FIG. 11 Is a view of the drive plate 258 and its method of rotating and causing either one or the other drive wheels 198 “OR” 200 to contact the drive plate 258. Which wheel it contacts will determine if the winch drum turns CW or CCW and that will raise or lower the lift platform. As can be seen on FIG. 11 and also in 9A, Shaft 300 rotates within bushings 201 and 207. The square steel cross bar, welded to the round shaft of 300 has solenoid 308 attached by its cable and pin 312 to one end and a spring 238 on its other end. When 12 volts is applied by the operators “UP” switch, solenoid 308 pulls the cross bar up and causes friction wheel 200 to contact drive plate 258. When the solenoid is released, spring 238 causes shaft 300 to rotate, friction wheel 200 looses contact to 258 and friction wheel 198 contacts the drive plate. This rocking of shaft 300 and engagement of either 198 OR 200 give the drive an up or down travel to the lift trolley and load platform. Further explanation of the drive assembly. As can be seen from the drawings, several factors will control the lift platforms lift speed. Drive plate speed (RPM), friction wheel diameter and distance located from the center of the drive plate, worm gear ratio, and lift cable winch drum diameter. The current design uses a 9″ diameter drive plate, 6″ diameter friction drive wheels on the input shafts of the worm gear drive (which has a ratio of 40:1, input to output shaft) and a 2½″ diameter winch drum. Engine speed (RPM) is an operator-controlled factor where the person operating the lifter can select a speed range. With ratios, wheel and winch diameter and the engine running at approximately 2,000 RPM full lift of the prototype, of approximately 5½ feet, will occur in approximately 5 seconds. The worm gear and its friction wheels are offset somewhat to the side of the 9″ drive plate giving the lowering of the load platform of approximately a 4 second period to go from a fill lift to its lowest setting.

Although the description above contains many specifics, these should not be construed as limiting the scope of the invention but as merely providing illustrations of some of the presently preferred embodiments of this invention. For example, the lift platform can have other shapes and sizes—such as forks, flat platform, bucket etc. The power source can be mounted on the lifter itself, or the tractors power can be used etc. Also, a worm gear winch is shown as the powering force that lifts the cable controlling the load platform. This power could also be provided by an electric winch, hydraulics etc.

Features such as rotating the forks 180 degrees effectively turns the lifter into a very useful rake. The operator controls, which consists of a lever toggle switch, has 3 positions: center off, “up” to lift (engages the lift solenoid 308 and engages the electric clutch 254) and a “down” switch position (engages the electric clutch 254 and in this down position the up solenoid 308 is not engaged, spring 238 pulls the drive plate 258 into the lift lowering position. As a safety, a micro switch is located close to the top of the lift range. This switch is in series with the up solenoid 308 and will open its circuit if the lift platform is raised to this safety height. A second backup safety is on engine “kill” micro switch immediately above the first. This switch will kill the engine in event of the first safety failing. The operator controls mentioned can be mounted in a small enclosure, possibly with a magnetic base or Velcro, to temporarily mount this control box close to the operator. Cable length from the lifter to the control box is a universal length as needed. Electric start and engine kill switch could also be provided in this box if the lifter has its own electric start engine.

Thus the scope of the invention should be determined by the appended claims and their legal equivalents, rather than by the examples given.

### BRIEF DESCRIPTION OF THE DRAWINGS

FIG. 1 Is an exploded perspective view of the load platform mounting showing forks and their method of being held in place and

FIG. 2 Shows a view of forks shown rotated 180 degrees and the assembly used as a rake.

FIG. 3a Is an exploded view of the trolley assembly. This assembly holds the lift forks assembly and has “V” groove rollers to guide and support it as it travels up and down the vertical support.

FIG. 3ab Is a head-on view of the “V” roller pulley.

FIG. 4a Shows further detail of the trolley assembly. The drop latch and solenoid.

FIG. 4b Shows the opposite side of the trolley supports with “Re-latch” pulley.

FIG. 4c Shows the upright trolley support cable and spring and:

FIG. 4d Shows the “Re-latch” cable attached to the fork assembly.

FIG. 5 Shows an exploded view of the axle assembly with bushings and caster wheels.

FIG. 6 A perspective view of the lifters main frame. Method of attaching to tractor is shown along with basic mounting of drive gear.

FIG. 7 Shows a perspective view of the upright support that the trolley travels up and down on and braces.

FIG. 8 A straight on view of the back side of the upright tube showing lift cable pulleys and mountings.

FIG. 9a Side view of engine and 12 volt clutch/brake and a view of the drive plate and gear drive.

FIG. 9b Shows a front view of the drive gear with the drive plate and friction wheels. Method of changing up or down lift motion is shown.

FIG. 9c Shows a top view of the worm drive, friction wheels and drive plates.

FIG. 10a Shows a perspective view of the main frame without drive gear.

FIG. 10b Shows the mounting to attach the lifter to a vehicle frame.

FIG. 10c Shows a side view of FIG. 10 as attached to the vehicle frame.

FIG. 11 Shows a perspective view of the drive plate assembly with solenoid and spring.

FIG. 12 Shows a complete view of the lifter.

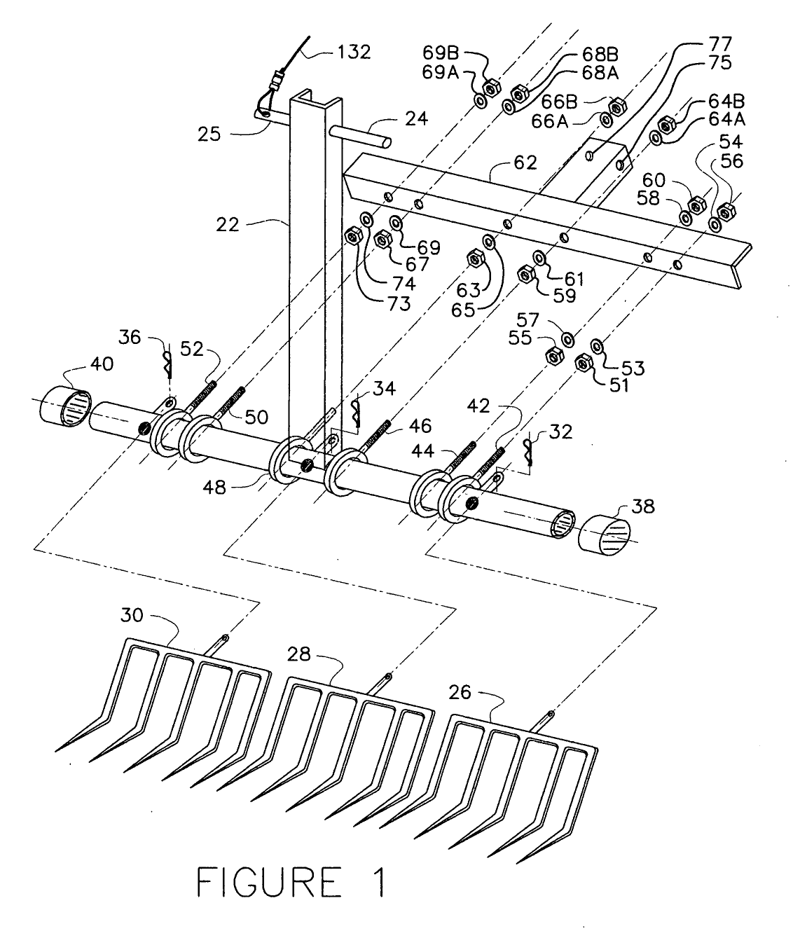

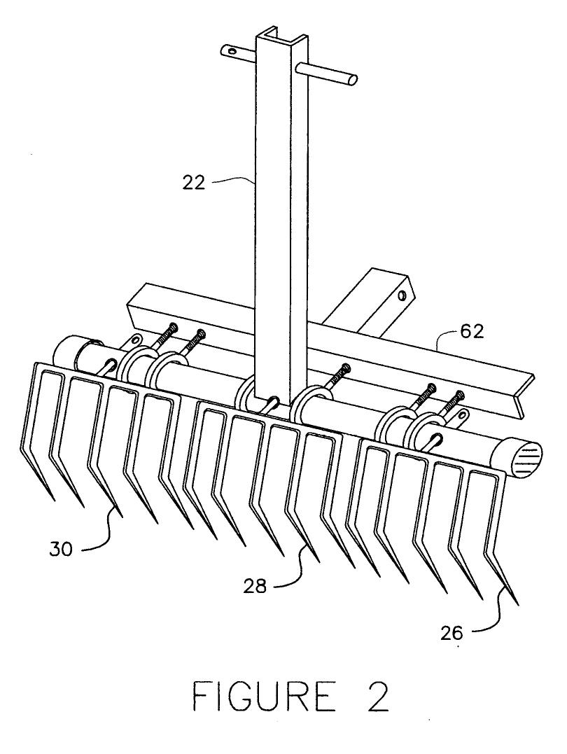

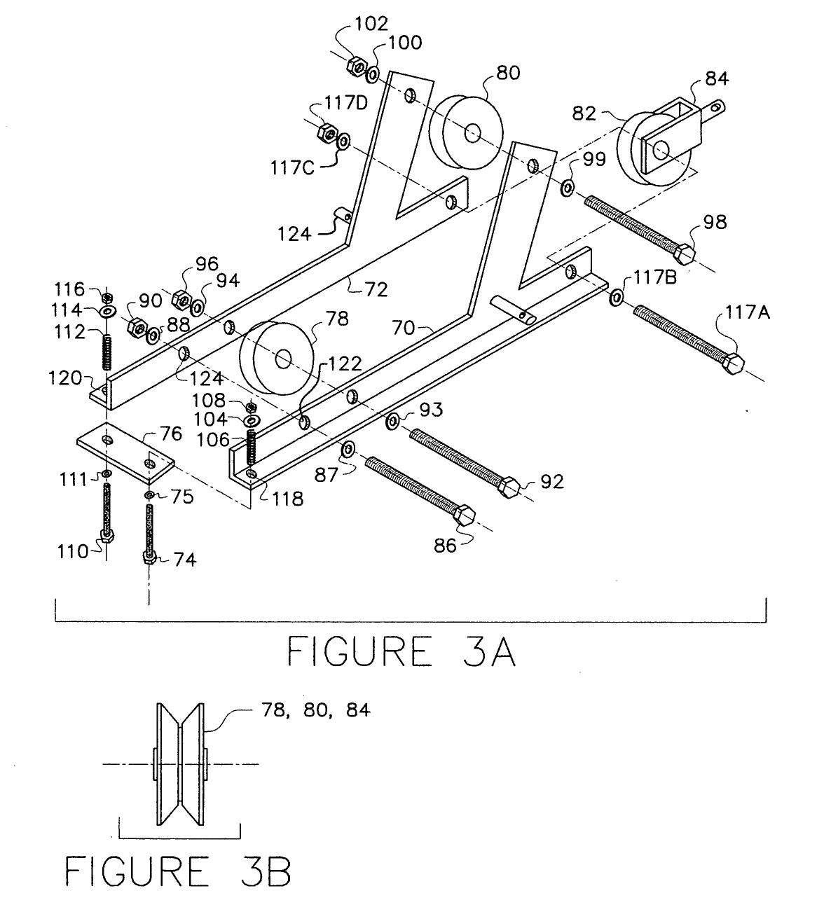

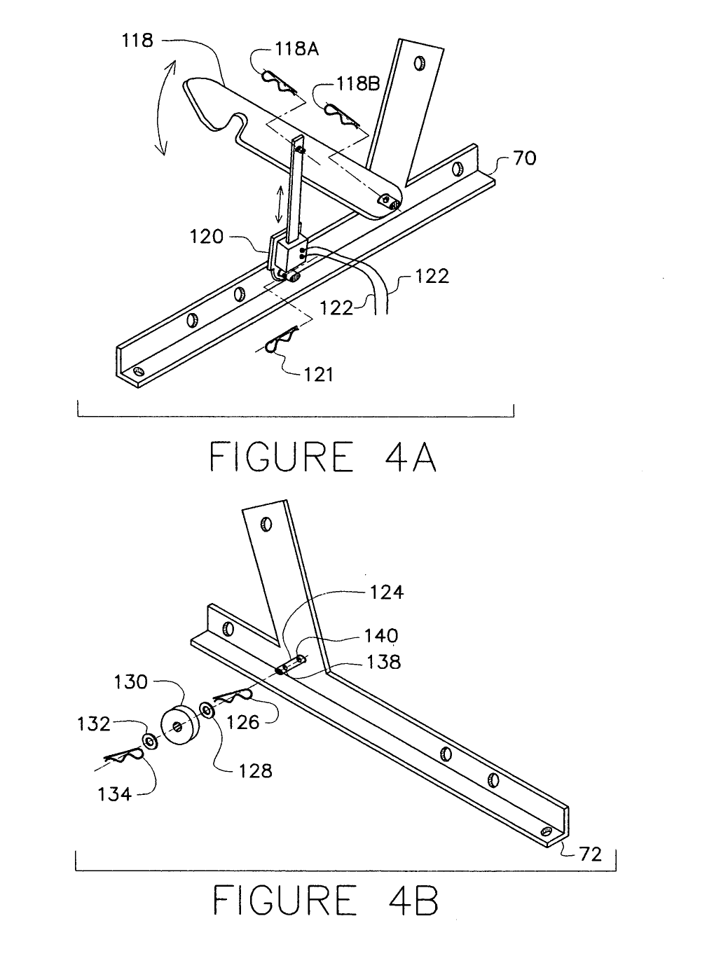

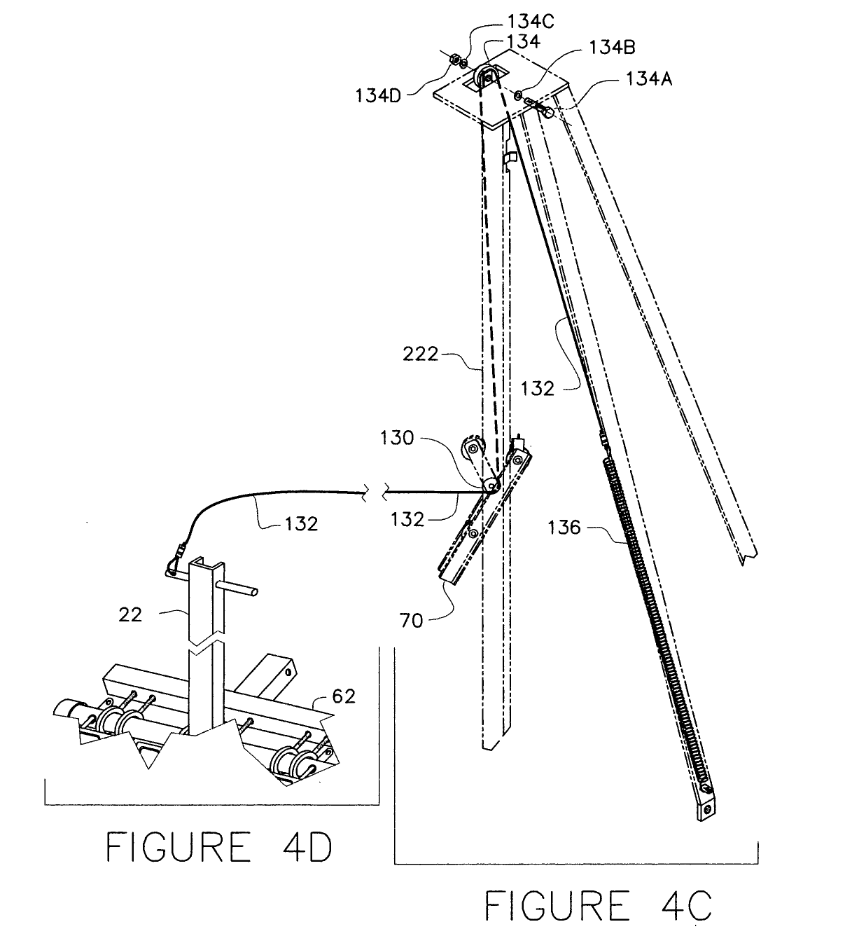

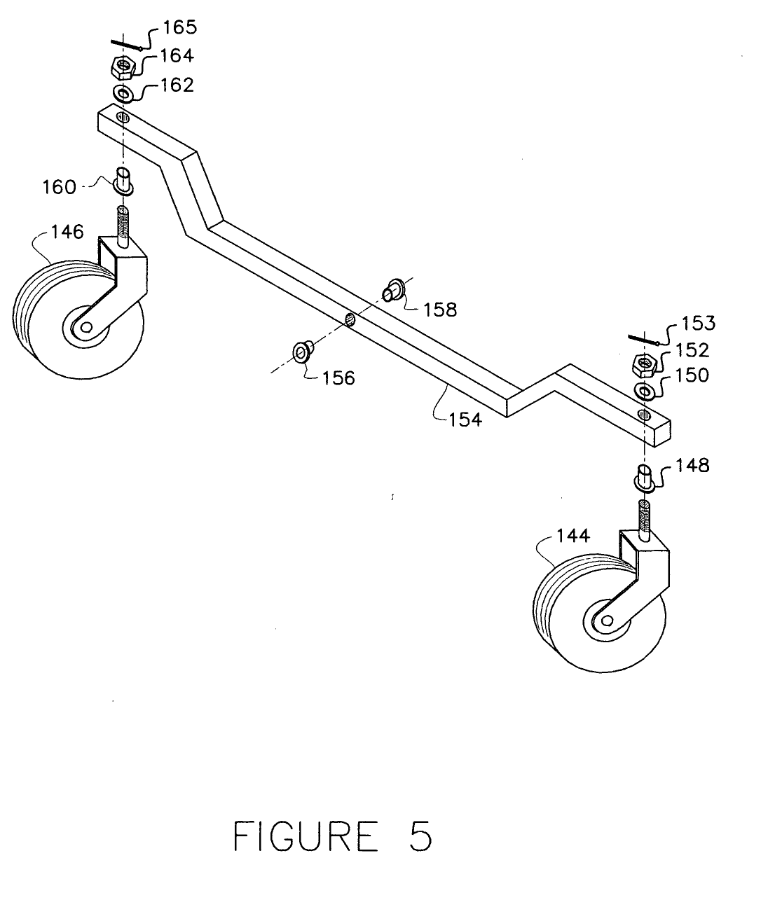

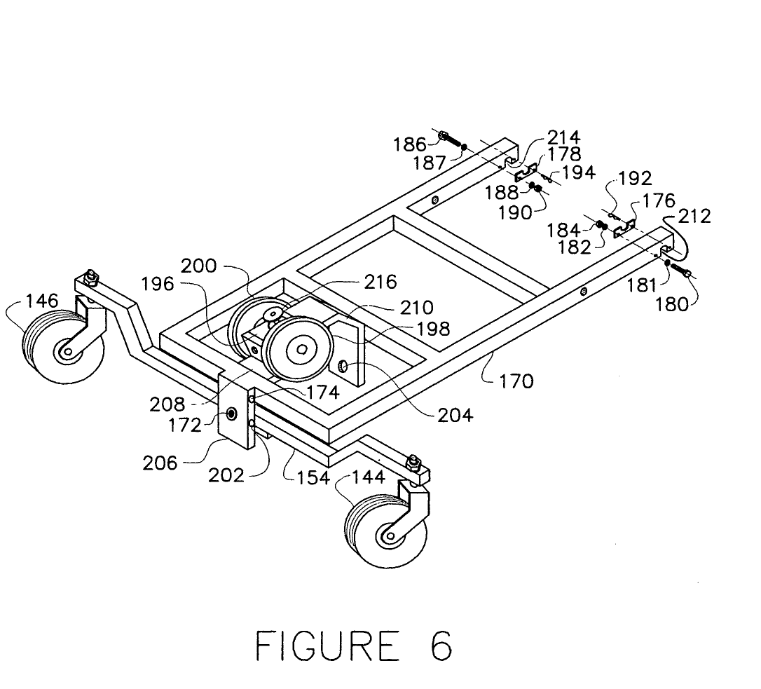

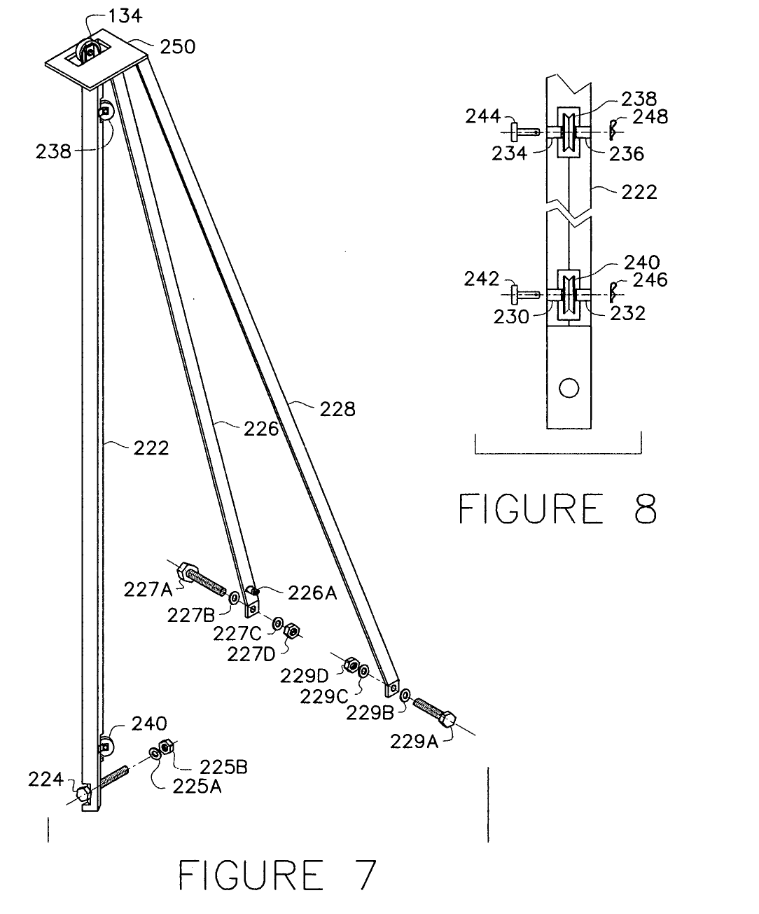

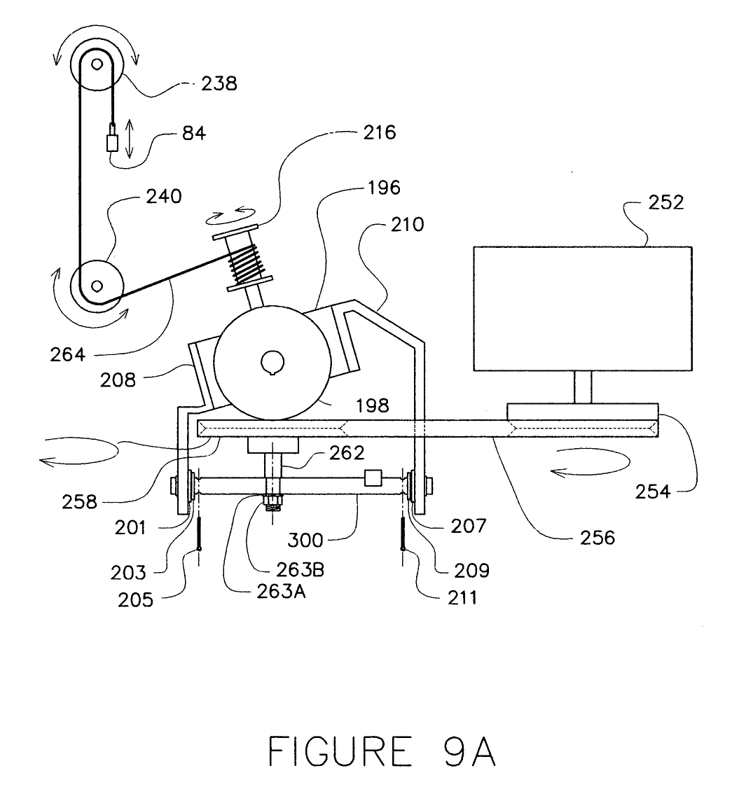

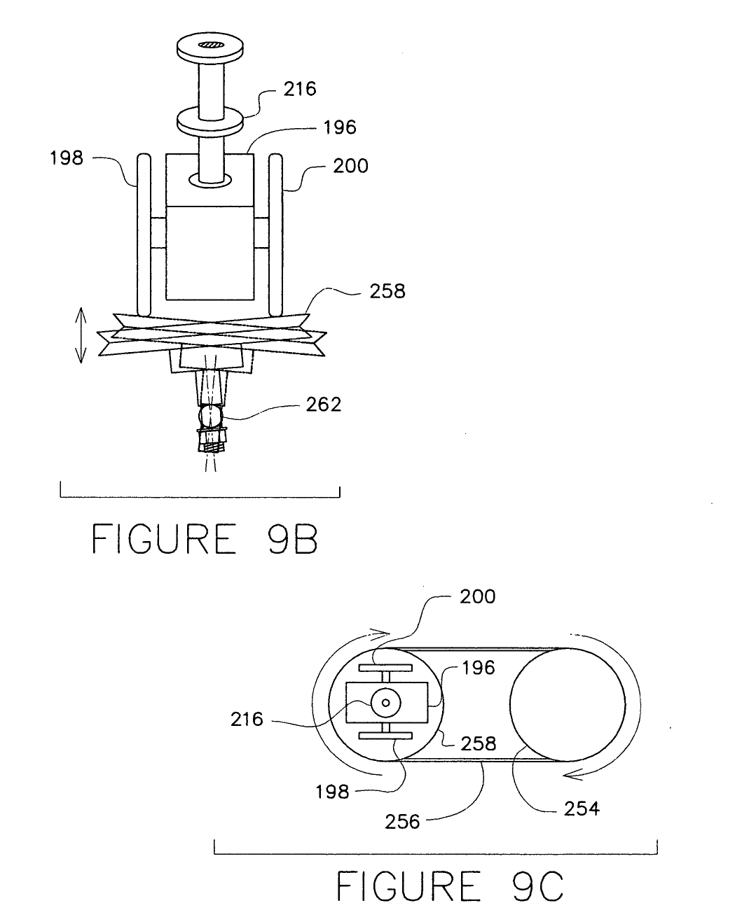

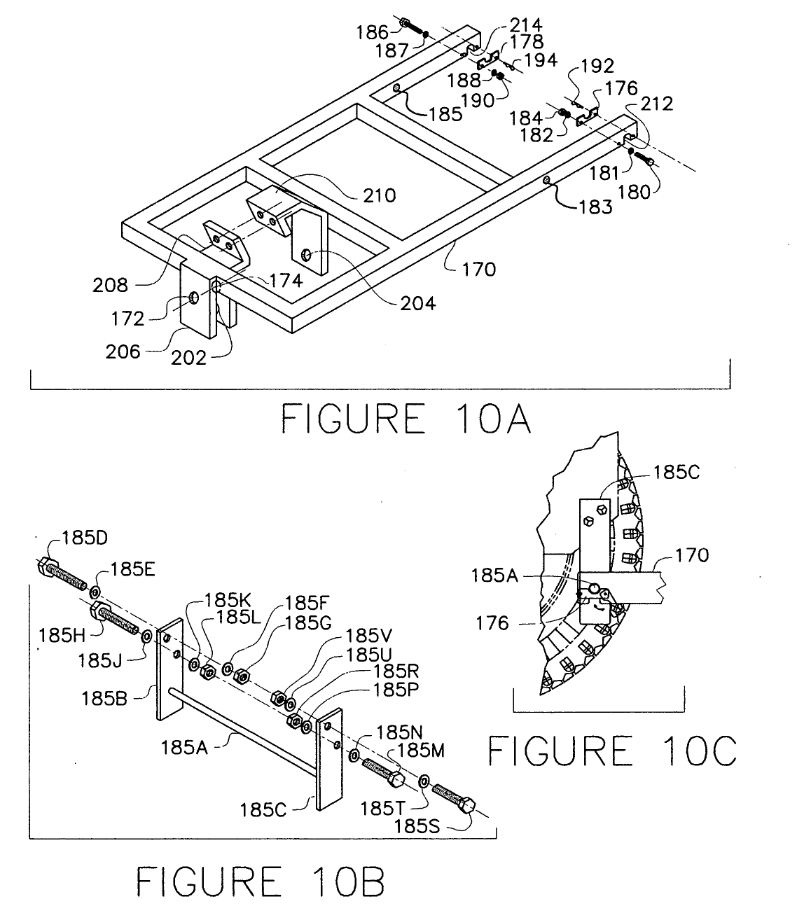

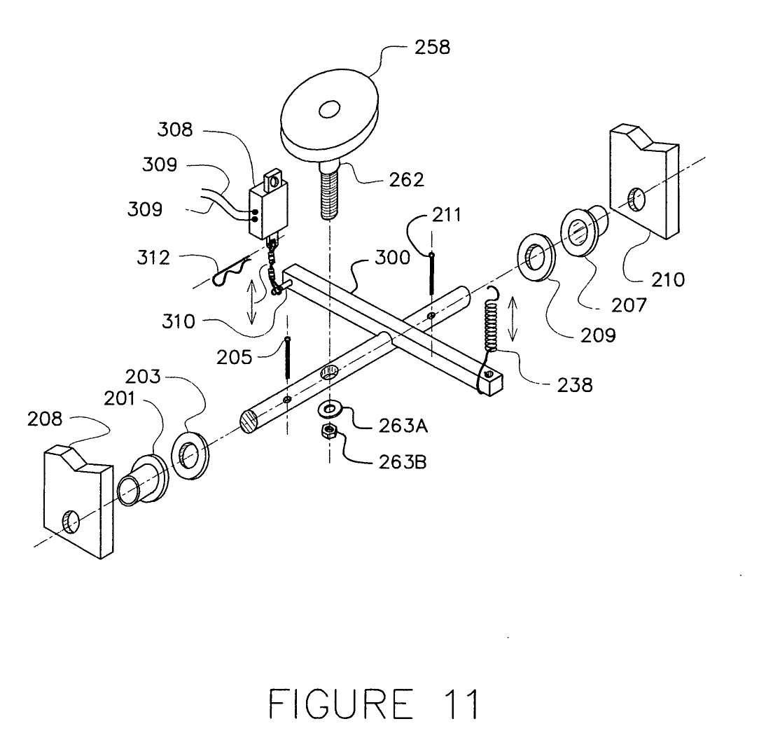

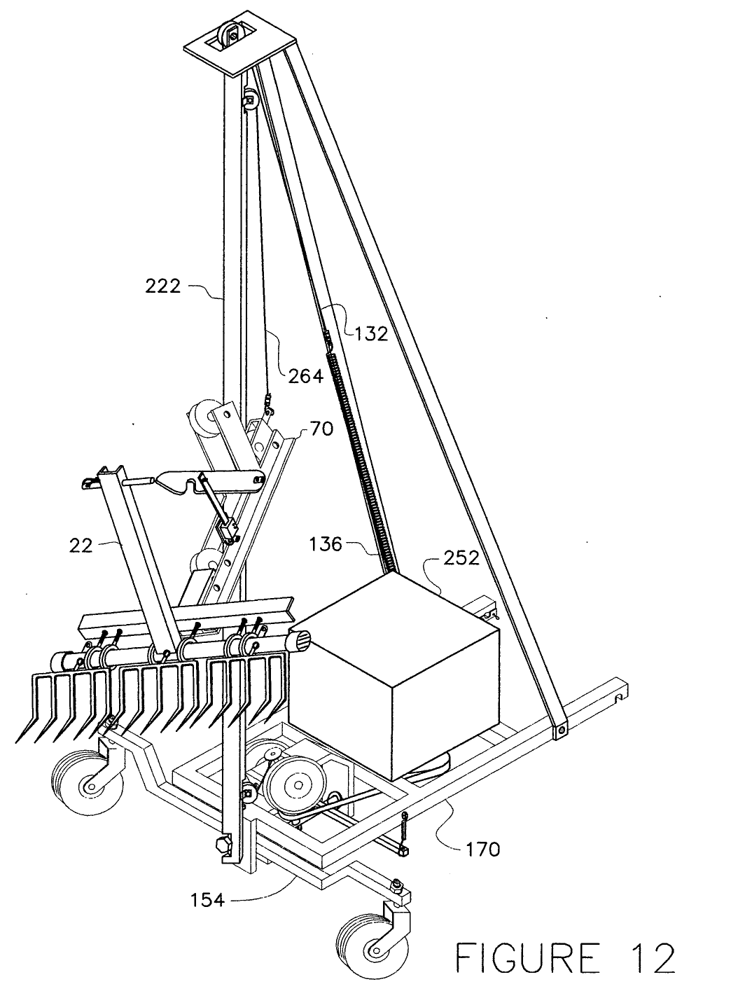

1. The attachable high lifting device comprising
(a) A supporting structure for the lift platform
(b) Means of supporting the lift platform
(c) Means of the lift form to travel on its support
(d) Means of coupling power source to the lift platform
(e) A power source for producing lifting energy
